(19) United States
(12) Patent Application Publication
(10) Pub. No.: US 2026/0292541 A1
(43) Pub. Date: Sep. 24, 2026

(54) TRAINING AND TESTING A MACHINE LEARNING MODEL BASED ON DATA REQUIRING DIFFERENT LEVELS OF PRIVACY

(71) Applicant: Telefonaktiebolaget LM Ericsson (publ), Stockholm (SE)

(72) Inventors: Illyyne SAFFAR, Le plessis-Robinson (FR); Adèle HARRISSART, Chatou (FR); Osama AROUK, Massy (FR); Laëtitia BARINGTHON, Palaiseau (FR)

(73) Assignee: Telefonaktiebolaget LM Ericsson (publ), Stockholm (SE)

(21) Appl. No.: 19/472,568

(22) PCT Filed: Apr. 6, 2023
(86) PCT No.: PCT/SE2023/050324

§ 371 Date: Oct. 3, 2025

(51) Int. Cl. H04W 24/02; H04L 41/16; H04W 24/10

(52) U.S. Cl. CPC H04W 24/02; H04L 41/16; H04W 24/10

(57) ABSTRACT

A method performed by a network slice controller associated with a network slice is provided. The method comprises obtaining measurement data that indicates performance of a network associated with the network slice and/or configuration information that indicates a configuration of the network slice and transmitting the obtained measurement data and/or the obtained configuration information to a network orchestrator that manages a plurality of network slices including the network slice. The network slice controller and the network orchestrator belong to a common network operator or a common vertical.

### TECHNICAL FIELD

This disclosure relates to training and testing a machine learning (ML) model based on data requiring different levels of privacy.

### BACKGROUND

With increasing complexity of 5G (and beyond) mobile networks, ML (e.g., artificial intelligence (AI)) will play a crucial role in the mobile networks not only for network management and orchestration, but also for reducing the operational cost (OPEX) by enabling autonomous operations.

One of the important steps in using ML is to collect data needed for training and/or testing an ML model (e.g., a neural network (NN) model) before deploying the ML model for inference (i.e., providing input data to the ML model, thereby obtaining output data).

### SUMMARY

However, in collecting data needed for training and/or testing an ML model, a privacy issue may arise. For example, there may be a scenario where a Mobile Network Operator (MNO) allows a part of its wireless network to be used by a private company while another part of its wireless network is used by the MNO. More specifically, in one example, a wireless carrier of a 5G/LTE network may allocate a first network slice of its wireless network to an airline company such that the airline company can use a part of the wireless carrier's network for communicating with its airplanes. Also, the wireless carrier may allocate a second network slice of its wireless network for its own usage (e.g., providing a wireless network to normal cell phone users).

In the above scenario, if the wireless carrier uses an ML model to optimize the performance of its wireless network, in order to train and/or test the ML model, the wireless carrier needs testing/training data. But the needed testing/training data may be available at different entities. For example, the needed testing/training data may include data associated with the first network slice and data associated with the second network slice. However, the airline company may not want to share its data associated with the first network slice with the wireless carrier due to privacy concerns. On the other hand, there is no privacy issue in the wireless carrier obtaining data associated with the second network slice because the second network slice is used by the wireless carrier itself. In a summary, there may be a scenario where it is not desirable to share some of the testing/training data (e.g., the data associated with the first network slice) with the MNO due to privacy concerns while it is okay to share other testing/training data (e.g., the data associated with the second network slice) with the MNO.

In order to solve this problem, in some embodiments, different methods of collecting the testing/training data are used depending on whether sharing the testing/training data may raise a privacy concern, and of transforming the collected testing/training data into the same space of the operator. More specifically, in some embodiments, the testing/training data is collected in different data formats depending on a privacy level associated with the testing/training data, and the collected testing/training data is transformed into the same space such that it can be used for training the ML model for optimizing the performance of the wireless network.

More specifically, in one aspect of some embodiments of this disclosure, there is provided a method performed by a network slice controller associated with a network slice. The method comprises obtaining measurement data that indicates performance of a network associated with the network slice and/or configuration information that indicates a configuration of the network slice. The method further comprises transmitting the obtained measurement data and/or the obtained configuration information to a network orchestrator that manages a plurality of network slices including the network slice. The network slice controller and the network orchestrator belong to a common network operator or a common vertical.

In another aspect, there is provided a method performed by a network slice controller associated with a network slice. The method comprises obtaining measurement data that indicates performance of a network associated with the network slice and/or configuration information that indicates a configuration of the network slice. The method further comprises obtaining a machine learning, ML, model for generating data samples from a learned data distribution of the obtained measurement data and/or the obtained configuration information. The method further comprises transmitting model parameters of the ML model to a network orchestrator that manages a plurality of network slices including the network slice, wherein the network slice controller and the network orchestrator belong to different network operators or verticals.

In another aspect, there is provided a method performed by a network slice controller associated with a network slice. The method comprises obtaining measurement data that indicates performance of a network associated with the network slice and/or configuration information that indicates a configuration of the network slice, and encoding the obtained measurement data and/or the obtained configuration information into encoded measurement data and/or encoded configuration information. The method further comprises transmitting the encoded measurement data and/or the encoded configuration information to a network orchestrator that manages a plurality of network slices including the network slice, wherein the network slice controller and the network orchestrator belong to different network operators or verticals.

In another aspect, there is provided a method performed by a network orchestrator managing a plurality of network slices. The method comprises receiving two or more of: (i) first measurement data that indicates performance of a first network associated with a first network slice and/or first configuration information that indicates a configuration of the first network slice, (ii) model parameters of a first machine learning, ML, model for generating data samples from a learned data distribution of second measurement data indicating performance of a second network associated with a second network slice and/or second configuration information indicating a configuration of the second network slice, and (iii) encoded measurement data that indicates performance of a third network associated with a third network slice and/or encoded configuration information that indicates a configuration of the third network slice. The method further comprises, based on two or more of: (i) the first measurement data and/or the first configuration information, (ii) the model parameters of the first ML model, or (iii) the encoded measurement data and/or the encoded configuration information, adjusting one or more configurations of one or more network slices included in the plurality of network slices. The first measurement data and/or the first configuration information were transmitted by a first network slice controller associated with the first network slice. The model parameters of the first ML model were transmitted by a second network slice controller associated with the second network slice. The encoded measurement data and/or the encoded configuration information were transmitted by a third network slice controller associated with the third network slice. The first network slice controller and the network orchestrator belong to a common network operator or a common vertical. The second network slice controller and the network orchestrator belong to different network operators or verticals, and the third network slice controller and the network orchestrator belong to different network operators or verticals.

In another aspect, there is provided a computer program comprising instructions which when executed by processing circuitry cause the processing circuitry to perform the method of any one of the embodiments described above.

In another aspect, there is provided a carrier containing the computer program of the embodiment described above, wherein the carrier is one of an electronic signal, an optical signal, a radio signal, and a computer readable storage medium.

In another aspect, there is provided a network slice controller associated with a network slice. The network slice controller is configured to obtain measurement data that indicates performance of a network associated with the network slice and/or configuration information that indicates a configuration of the network slice; and transmit the obtained measurement data and/or the obtained configuration information to a network orchestrator that manages a plurality of network slices including the network slice, wherein the network slice controller and the network orchestrator belong to a common network operator or a common vertical.

In another aspect, there is provided a network slice controller associated with a network slice. The network slice controller is configured to obtain measurement data that indicates performance of a network associated with the network slice and/or configuration information that indicates a configuration of the network slice; and obtain a machine learning, ML, model for generating data samples from a learned data distribution of the obtained measurement data and/or the obtained configuration information. The network slice controller is further configured to transmit model parameters of the ML model to a network orchestrator that manages a plurality of network slices including the network slice, wherein the network slice controller and the network orchestrator belong to different network operators or verticals.

In another aspect, there is provided a network slice controller associated with a network slice. The network slice controller is configured to obtain measurement data that indicates performance of a network associated with the network slice and/or configuration information that indicates a configuration of the network slice; encode the obtained measurement data and/or the obtained configuration information into encoded measurement data and/or encoded configuration information; and transmit the encoded measurement data and/or the encoded configuration information to a network orchestrator that manages a plurality of network slices including the network slice, wherein the network slice controller and the network orchestrator belong to different network operators or verticals.

In another aspect, there is provided a network orchestrator managing a plurality of network slices. The network orchestrator is configured to receive two or more of: (i) first measurement data that indicates performance of a first network associated with a first network slice and/or first configuration information that indicates a configuration of the first network slice, (ii) model parameters of a first machine learning, ML, model for generating data samples from a learned data distribution of second measurement data indicating performance of a second network associated with a second network slice and/or second configuration information indicating a configuration of the second network slice, and (iii) encoded measurement data that indicates performance of a third network associated with a third network slice and/or encoded configuration information that indicates a configuration of the third network slice. The network orchestrator is configured to, based on two or more of: (i) the first measurement data and/or the first configuration information, (ii) the model parameters of the first ML model, or (iii) the encoded measurement data and/or the encoded configuration information, adjust one or more configurations of one or more network slices included in the plurality of network slices. The first measurement data and/or the first configuration information were transmitted by a first network slice controller associated with the first network slice, and the model parameters of the first ML model were transmitted by a second network slice controller associated with the second network slice. The encoded measurement data and/or the encoded configuration information were transmitted by a third network slice controller associated with the third network slice, and the first network slice controller and the network orchestrator belong to a common network operator or a common vertical. The second network slice controller and the network orchestrator belong to different network operators or verticals, and the third network slice controller and the network orchestrator belong to different network operators or verticals.

In another aspect, there is provided an apparatus comprising a processing circuitry, and a memory, said memory containing instructions executable by said processing circuitry, whereby the apparatus is operative to perform the method of any one of the embodiments described above.

Some embodiments of this disclosure provide a new privacy-constrained AI/ML multi-level orchestration that allows heterogeneous data collection from different entities in the context of the Open and/or Cloud (Native) Radio Access Network (RAN). This new privacy-constrained AI/ML multi-level orchestration allows training and/or testing an ML global model using privacy sensitive data that requires different levels of privacy.

### BRIEF DESCRIPTION OF THE DRAWINGS

The accompanying drawings, which are incorporated herein and form part of the specification, illustrate various embodiments.

FIG. 1 shows an exemplary scenario where some embodiments of this disclosure can be implemented.

FIG. 2 shows a process according to some embodiments.

FIG. 3A shows an autoencoder for a vertical entity according to some embodiments.

FIG. 3B shows an autoencoder for a network orchestrator according to some embodiments.

FIG. 3C shows a system according to some embodiments.

FIG. 4 illustrates a mapping from a source latent space to a target latent space according to some embodiments.

FIG. 5 illustrates a user-case scenario where some embodiments of this disclosure can be implemented.

FIG. 6 shows a process according to some embodiments.

FIG. 7 shows a process according to some embodiments.

FIG. 8 shows a process according to some embodiments.

FIG. 9 shows a process according to some embodiments.

FIG. 10 shows an apparatus according to some embodiments.

### DETAILED DESCRIPTION

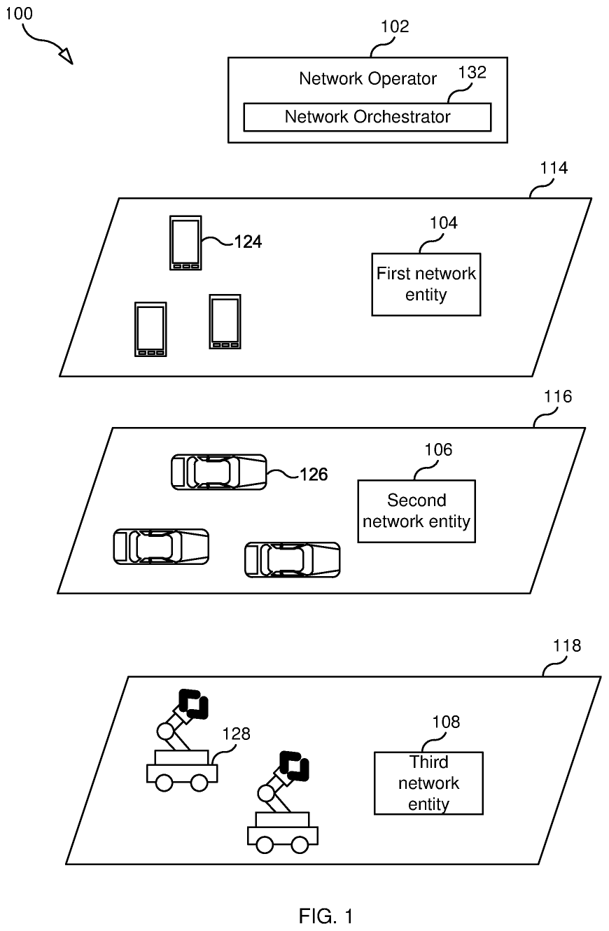

FIG. 1 shows an exemplary scenario 100 where some embodiments of this disclosure can be implemented. In the scenario 100, a network operator 102 is configured to provide a wireless network to first, second, and third network entities 104, 106, and 108. More specifically, the network operator 102 is configured to provide a first network slice 114 to the first network entity 104, a second network slice 116 to the second network entity 106, and a third network slice 118 to the third network entity 108.

One example of the “network entity” is a “vertical entity.” A vertical entity is a network entity owned by a vertical. A “vertical” is defined as any industrial sector that benefits and uses a wireless network (e.g., 5G network) system. Examples of the vertical are: transportation industry (e.g., trains, buses, etc.), internet of things (IoT) industry, electricity distribution industry, public safety industry, media and entertainment industry, etc.

The network operator 102 is configured to provide a wireless network service to various customers ranging from user equipment (UE) (e.g., cell phone) users to industrial users, and the vertical entities correspond to the industrial users that use the wireless network service for their businesses.

In the scenario 100, the network entity (“NE”) 104 is owned by the network operator 102 and is controlled directly by the network operator 102. The NE 104 is configured to provide a wireless network service to normal UE users (e.g., cell phone users) 124.

The NEs 106 and 108 are not owned by the network operator 102. The NEs 106 and 108 are owned by different verticals (meaning that the NEs 106 and 108 are vertical entities). The NE 106 is configured to provide a wireless network service to smart vehicles 126 (e.g., autonomous driving cars), and the NE 108 is configured to provide a wireless network service to autonomous manufacturing equipment 128 (e.g., autonomous manufacturing robots).

The network operator 102 may include a network orchestrator 132. The network orchestrator 132 is configured to run an ML model to optimize the network operator 102's wireless network. For example, the ML model may be configured to output values of network configuration parameters for optimizing the wireless network (e.g., how to perform a network slice management) based on current state of the wireless network.

One way of the network orchestrator 132 to determine the current state of the wireless network is by collecting from each of the NEs 104-108 measurement data (e.g., throughput, latency, packet loss, etc.) indicating performance of the network associated with the first, second, and third network slices 114-118 and configuration information (e.g., beamforming width) indicating configurations of the first, second, and third network slices 114-118.

But, because the NEs 106 and 108 (a.k.a., NEs 106 and 108) are not owned by the network operator 102, there may be a scenario where the NEs 106 and 108 do not want to share the measurement data and/or the configuration information with the network operator 102. For example, in case that the measurement data and the configuration information indicate detailed locations of devices connected to the wireless network, the NEs 106 and 108 may not want to share the measurement data and the configuration information for privacy protection purpose. On the other hand, because the NE 104 is owned by the network operator 102, there is no privacy issue in the NE 104 sharing the measurement data and the configuration information with the network operator 102.

Accordingly, in some embodiments, depending on the level of privacy required for the measurement data and/or the configuration information, the measurement data and/or the configuration information is shared with the network operator 102 in different ways.

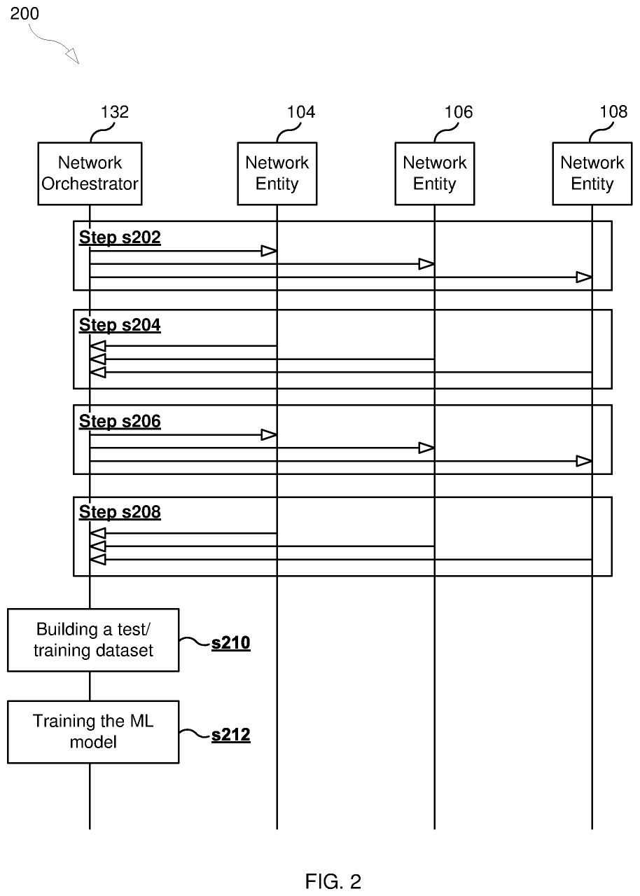

FIG. 2 shows a process 200 for performing a privacy-constrained multilevel heterogenous data orchestration according to some embodiments. By performing the privacy-constrained multilevel heterogenous data orchestration, the measurement data and/or the configuration information requiring different levels of privacy can be collected at the network operator 102.

Process 200 may begin with step s202. Step s202 comprises the network orchestrator 132 sending to each of the NEs 104-108 a request for sending information related to a level of privacy required or desired for the measurement data and/or the configuration information available at each of the NEs 104-108.

After performing step s202, in step s204, each of the NEs 104-108 may send the requested information related to a required or desired level of privacy. For example, the information that the first NE 104 sends to the network orchestrator 132 in step s204 may indicate that the lowest level of privacy is required for measurement data and/or configuration information available at the first NE 104. On the contrary, the information that the second NE 106 sends to the network orchestrator 132 in step s204 may indicate that the highest level of privacy is required for measurement data and/or configuration information available at the second NE 106. Also, the information that the third NE 108 sends to the network orchestrator 132 in step s204 may indicate that the medium level of privacy is required for measurement data and/or configuration information available at the third NE 108.

In some embodiments, the network orchestrator 132 may already have the information related to a level of privacy required or desired for the measurement data and/or the configuration information available at each of the NEs 104-108. In such case, steps s202 and s204 may be skipped.

In step s206, the network orchestrator 132 may transmit a request for a specific type of measurement data and/or configuration information according to the level of privacy associated with each of the NEs 104-108. For example, the network orchestrator 132 may transmit a request for raw measurement data and/or configuration information to the first NE 104, a request for encoded measurement data and/or encoded configuration information to the second NE 106, and a request for model parameters identifying an ML model that can be used for estimating measurement data and configuration information to the third NE 108. More detailed information about the raw data/information, the encoded data/information, and the model parameters are provided below.

In some embodiments, instead of sending a request for a specific type of measurement data and/or configuration information, the network orchestrator 132 may send to each of the NEs 104-108 a general request for measurement data and/or configuration information without specifying the type. In such embodiments, each of the NEs 104-108 may send to the network orchestrator 132 one of the raw data/information, the encoded data/information, and the model parameters depending on the level of privacy associated with each of the NEs 104-108.

After receiving the request, in step s208, each of the NEs 104-108 may send to the network orchestrator 132 the requested information (i.e., the requested testing/training data).

### Low Privacy Level

The NE 104 may be configured to obtain first measurement data indicating performance of a network associated with the first network slice 114 and/or first configuration information indicating a configuration of the first network slice 114. After obtaining the first measurement data and/or the first configuration information, the NE 104 may send to the network orchestrator 132 the obtained first measurement data (i.e., the raw measurement data) and/or the obtained first configuration information (i.e., the raw configuration information). As explained above, this sharing does not raise any privacy issue here because the NE 104 is owned by the network operator 102.

### High Privacy Level

Like the NE 104, the NE 106 is configured to obtain second measurement data indicating performance of a network associated with the second network slice 116 and/or second configuration information indicating a configuration of the second network slice 116. But contrary to the NE 104, it may not be desirable for the NE 106 to share the obtained second measurement data and/or the second configuration information with the network orchestrator 132 because of the privacy issue discussed above.

Thus, in some embodiments, instead of sharing the obtained second measurement data and/or the second configuration information, the NE 106 may share information that may be used by the network orchestrator 132 to derive or estimate the obtained second measurement data and/or the second configuration information. In deriving and/or estimating the obtained second measurement data and/or the second configuration information, autoencoders and latent space mapping technique may be used.

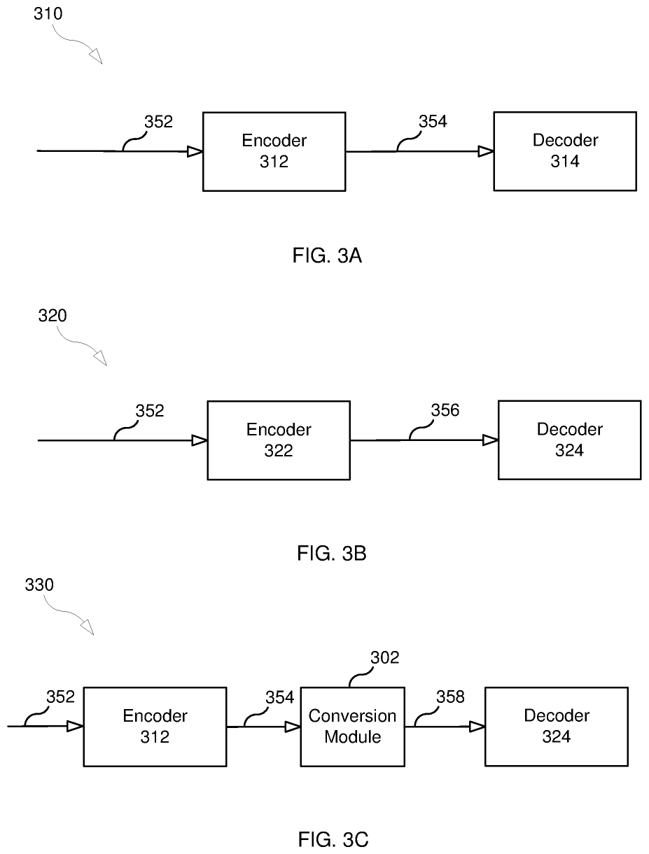

More specifically, in some embodiments, the NE 106 may use an encoder 312 of an autoencoder 310 (shown in FIG. 3A) that the NE 106 has for encoding the second measurement data and/or the second configuration information. The network orchestrator 132 may use a decoder 324 of an autoencoder 320 that the network orchestrator 132 has for decoding the encoded measurement data and/or the encoded configuration information, thereby reconstructing/deriving/estimating the second measurement data and/or the second configuration information (i.e., generating the second measurement data and/or the second configuration information or generating data that is similar to the second measurement data and/or the second configuration information).

As shown in FIG. 3A, the autoencoder 310 comprises the encoder 312 and a decoder 314. The encoder 312 is configured to encode input data 352, thereby generating encoded data 354. The decoder 314 is configured to decode encoded data 354, thereby reconstructing input data 352 (i.e., generating input data 352 or generating data that is similar to input data 352). Similarly, as shown in FIG. 3B, the autoencoder 320 comprises an encoder 322 and the decoder 324. The encoder 322 is configured to encode input data 352, thereby generating encoded data 356, and the decoder 324 is configured to decode encoded data 356, thereby reconstructing input data 352 (i.e., generating input data 352 or generating data that is similar to input data 352).

The decoder 324 of the autoencoder 320 is configured to decode the data that is encoded using the encoder 322. Thus, if the second measurement data and/or the second configuration information is encoded using the encoder 312, the decoder 324 may not correctly reconstruct the second measurement data and/or the second configuration information.

Therefore, according to some embodiments, a conversion module 302 shown in FIG. 3C is provided. This conversion module 302 is configured to map the latent space of the autoencoder 310 at the NE 106 to the latent space of the autoencoder 320 at the network orchestrator 132. More specifically, this conversion module 302 is configured to convert encoded measurement data and/or configuration information outputted by the encoder 312 into encoded data 356 (or data that is similar to encoded data 356) such that encoded data 356 (not encoded data 354) is provided to the decoder 324. By decoding encoded data 356 rather than encoded data 354, the decoder can reconstruct input data 352 (i.e., the second measurement data and/or the second configuration information) better.

Since this projection or mapping requires sharing only the latent spaces (i.e., encoded data 354 and/or 356) between the NE 106 and the network orchestrator 134, it removes the need of sharing the raw measurement data and/or the raw configuration information and the need of sharing a part of or the whole ML model.

This projection or mapping (herein after, “mapping”) is based on a machine learning technique and more precisely on Transfer Learning (TL) and domain adaptation. The mapping comprises transferring knowledge learned in one or several settings (e.g., autoencoders from the NEs) to another settings (e.g., autoencoders from the network operator 102) that share similarities but not the exact same distribution. The differences between the two settings may come from the fact that each autoencoder can have a different architecture, a different objective (e.g., high performance, or a trade-off between performance and complexity of the architecture), or even that the autoencoders were trained on different training datasets.

Detailed information about mapping of the source latent space (e.g., encoded data 354) to the target latent space (e.g., encoded data 356) is provided below.

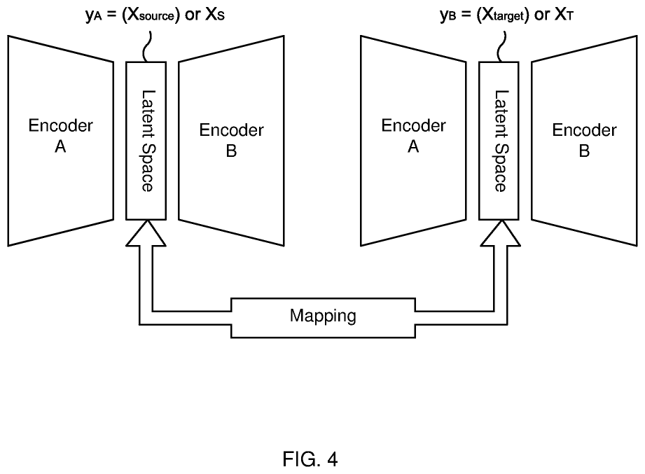

FIG. 4 illustrates a mapping between the source latent space (i.e., the latent space from an autoencoder A) and the target latent space (i.e., the latent space from an autoencoder B). In FIG. 4, y_{A}=X_{source} or X_{S} is the latent space from the autoencoder A (i.e., the source), and y_{B}=X_{target} or X_{T} is the latent space from the autoencoder B (i.e., the target). Two data domains for the source and the target with the marginal probabilities—p_{S} and p_{T}—are defined as D_{S}=(X_{S}, p_{S}) and D_{T}=(X_{T}, P_{T}).

Note that, in order to facilitate the mapping of one latent space to another latent space, it is desirable that X_{S} and X_{T} have the same dimension and are built from the same initial inputs (features) that are fed to the autoencoders A and B (e.g., it is desirable that initial input features have the same dimension in the encoder as well as in the decoder). In case where X_{S} and X_{T} do not have the same dimension (and/or where the initial inputs (features) don't have the same dimension), a technique from a subfield of domain adaptation called heterogenous domain adaptation can be used. However, it is much more complicated to ensure its quality/accuracy when X_{S} and X_{T} do not have the same dimension (and/or where the initial inputs (features) don't have the same dimension).

Referring back to FIG. 4, the problem is finding and applying a function mapping, aligning, or projecting (herein after, just “mapping”) X_{S} to X_{T} (e.g., how to align D_{S} and D_{T}, which falls in the area of unsupervised domain adaptation), thereby reducing the mismatch between the latent spaces X_{S} and X_{T} (or latent distributions) of the encoder and the decoder (or of two autoencoders coming from different trained networks) without sharing any training data or any parts of NNs corresponding to the autoencoders.

There are many different ways of performing the mapping of the source latent space X_{S} to the target latent space X_{T}. Examples of the ways of performing the mapping are the followings:

### 1. Subspace Alignment

In some embodiments, the mapping of the source latent space X_{S} to the target latent space X_{T} may be performed based on subspace alignment.

For example, according to some embodiments, both latent spaces X_{S} and X_{T} may be projected into a common shared subspace such that a common representation of both the source and target latent spaces can be found.

In another example, according to some embodiments, the source latent space X_{S} is projected into the target latent space X_{T}. A linear transformation may be learned to map the source space to the target space. Basis vectors may be aligned by using a transformation matrix M from X_{S} to X_{T} (M∈ [symbol] ^{d×d}), where d is the dimensions of both X_{S} and X_{T}. M may be learned by minimizing the Bregman matrix divergence:

$$M *= {argmin}_{M} ( F ( M ) ) with F ( M ) = {‖ {X}_{s} M - {X}_{T} ‖}_{F}^{2} ,$$

where

$${‖ \cdot ‖}_{F}^{2}$$

is the Frobenius norm, and M* is the optimal matrix mapping the source space to the target space.

### 2. Optimal Transport

In some embodiments, the mapping of the source latent space X_{S} to the target latent space X_{T} may be performed based on optimal transport.

Optimal transport was initially introduced by Monge in 1781 to optimize the resource allocation by minimizing the transport cost from a set of factories to a set of mines. More formally, let Ω⊆ [symbol] ^{d} be a space and P(Ω) be the set of all probability measures over Ω. Given two probability measures μ and μ′∈P(Ω), the Monge-Kantorovich problem consists in finding a probabilistic coupling γ defined as a joint probability measure over Ω×Ω with marginals μ and μ′∀x, y∈Ω that minimizes the cost of transport regarding some function c.

In optimal transport domain adaptation, the goal is finding an alignment that minimizes the cost of transportation between two distributions. According to optimal transport theory, there exists a transport T that pushes the source domain to the target domain.

Using such implementation is totally unsupervised, thus the NEs don't need to share any data or partial/total architectures of their AE. However, this method may be very consuming.

In other embodiments, the optimal transport domain adaptation can be based on Joint distribution optimal transport (based on Monge-Kantorovich theorem) or the optimal transport.

### 3. Marginal Distance Alignment

In some embodiments, the mapping of the source latent space X_{S} to the target latent space X_{T} may be performed based on marginal distance alignment. Marginal distance alignment process may comprise the following steps:
Step 1) Computing an estimate of the empirical probability distribution function ƒ(X_{S}) using the collected measurements from the source latent space (i.e., the latent space of the autoencoder A).
Step 2) Determine a set of parameters (a₁, . . . , a_{N}) of a parametric mapping function T as follows.
Step 2-1) Initiate the mapping function T with initial parameters (a₁, . . . , a_{N})=(â₁, . . . , â_{N}).
Step 2-2) Apply the mapping function T to the measurements from the latent space of autoencoder A (i.e., the source latent space).
Step 2-3) Compute an estimate of the empirical probability distribution function g(X_{T}) using measurements from the mapping of the latent space of autoencoder B (i.e., the target latent space).
Step 2-4) Compute the distance between the probability density functions ƒ(X_{S}) and g(X_{T}) using the Kullback-Leibler divergence measure D_{KL}:

$${D}_{KL} ( f ‖ g ) = {\sum }_{x} f ( x ) log ( \frac{f ( x )}{g ( x )} )$$

where a lower value implies a lower distance between the probability distributions and hence better matching of the latent spaces of autoencoder A and autoencoder B (i.e., the source latent space and the target latent space).
Step 2-5) Update the parameters of the mapping function T to minimize the Kullback-Leibler divergence measure between the probability density functions ƒ(x) and g(x) as follows: (a₁, . . . , a_{N})=argmin(D_{KL}(ƒ∥g)).

Steps 2-2 through steps 2-5 are repeated until the computed measure D_{KL}(ƒ∥g) in step 2-4 becomes lower than a first threshold, or the reductions in this measure in subsequent iterations become lower that a second threshold.

### Middle Privacy Level

As explained above, because the NE 108 is not owned by the network operator 102, the third measurement data and/or the third configuration information cannot be shared directly with the network orchestrator 132. However, the third measurement data and/or the third configuration information may not be as private sensitive as the second measurement data and/or the second configuration information.

In such scenario, instead of sharing encoded measurement data and/or encoded configuration information (like the NE 106), the NE 108 may share a local ML model that can generate data samples from a learned data distribution of the third measurement data and/or the third configuration information. By sharing the local ML model instead of the raw third measurement data and/or the third configuration information, the amount of data that needs to be transferred to the network orchestrator 142 can be reduced.

The local ML model here may be configured to generate data samples (a.k.a., “synthetic data”) from a learned data distribution of the third measurement data and/or the third configuration information, using raw input data (i.e., raw measurement data and/or raw configuration information) received from different entities.

In some embodiments, the local ML model is a Gaussian mixture model (GMM). GMM is parameterized by two types of values, the mixture component weights, and the component means and variances/covariances. For a GMM with K components, the k^{th} component has a mean of μₖ and variance of σₖ for the univariate case and a mean of μₖ and covariance matrix of Σₖ for the multivariate. The mixture component weights are defined as φₖ for component Cₖ, with the constraint that

$${\sum }_{i = 1}^{K} {ϕ}_{i} = 1$$

so that the total probability distribution normalizes to 1.

$$p ( x ) = {\sum }_{i = 1}^{k} {ϕ}_{i} 𝒩 ( x \vert {μ}_{i} , {\sum }_{i} )$$

$$𝒩 ( x \vert {μ}_{i} , {\sum }_{i} ) = \frac{1}{\sqrt{( {( 2 π )}^{K} \vert {\sum }_{i} \vert )}} exp ( - \frac{1}{2} {( x - {μ}_{i} )}^{T} {( {\sum }_{i} )}^{- 1} ( x - {μ}_{i} ) )$$

In some embodiments the local ML model can be an autoregressive model in which the joint distribution can be modelled as a product of one-dimensional conditional densities using the probability chain rule, i.e., ∀x∈R^{d}, where the probability distribution of x is given by:

$$p ( x ) = {\prod }_{i = 1}^{d} p ( {x}^{i} \vert {x}^{i < d} )$$

In some embodiments, the local ML model can be any other model capable of estimating the distribution: GANs, Autoencoders, etc.

Referring back to FIG. 2, after collecting the training and/or testing data (i.e., the raw first measurement data and/or the raw first configuration information, the encoded second measurement data and/or the encoded configuration information, and the model parameters identifying the local ML model which can estimate a distribution of the third measurement data and/or the third configuration information), in step s210, the network orchestrator 132 may build a training/testing dataset for training/testing the global ML model using the collected data.

More specifically, for the low privacy level data, the network orchestrator 132 may just add the raw measurement data and/or the raw configuration information to the dataset. For the high privacy level data, the network orchestrator 132 may use the conversion module 302 shown in FIG. 3C and the decoder 324 shown in FIG. 3B to decode the encoded second measurement data and the encoded second configuration information, thereby obtaining decoded measurement data and/or the decoded configuration information. For the medium level privacy level data, the network orchestrator 132 may use the local ML model to generate synthetic data indicating a distribution of the second measurement data and/or the second configuration information and map the synthetic data to the raw data space using Transfer Learning.

If the target is labelled, supervised TL tasks may be executed. These TL tasks may be based on, for example, freezing some layers at the source model and then retraining the remaining layers in order to fine tune the model according to the new data.

If the target is unlabelled, unsupervised TL tasks can be executed. These TL tasks may be based on, for example, domain adversarial neural networks (DANNs) or joint adaptation networks (JANs).

In some embodiments where the generated data is not labelled, the target can be either labelled or unlabelled. In these embodiments, the TL can be conducted by mapping the source space to the target space via a projection (like subspace alignment) or via function (like optimal transport).

Referring back to FIG. 2, after building the training/testing dataset, in step s212, the network orchestrator 132 may train/test the global ML model using the training/testing dataset.

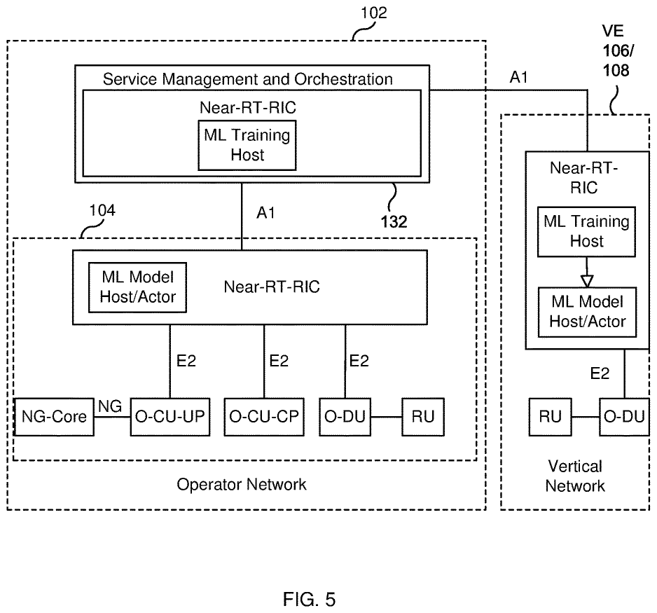

FIG. 5 illustrates a use-case example of implementing some embodiments of this disclosure in the context of Open-RAN (“O-RAN”). As shown in FIG. 5, in the network operator 102, the ML model can be trained and hosted at near RAN Intelligence Controller (Near-RT RIC), or at Non-RT RIC, or at Near-RT RIC and Non-RT RIC. Also, as further shown in FIG. 5, the NE 104 may transmit the first measurement data and/or the first configuration information to the orchestrator 132 via the standardized interface “A1,” and the NE 106/108 may transmit to the orchestrator 132 the ML model/the encoded measurement data and/or the encoded configuration information via the standardized interface “A1.”

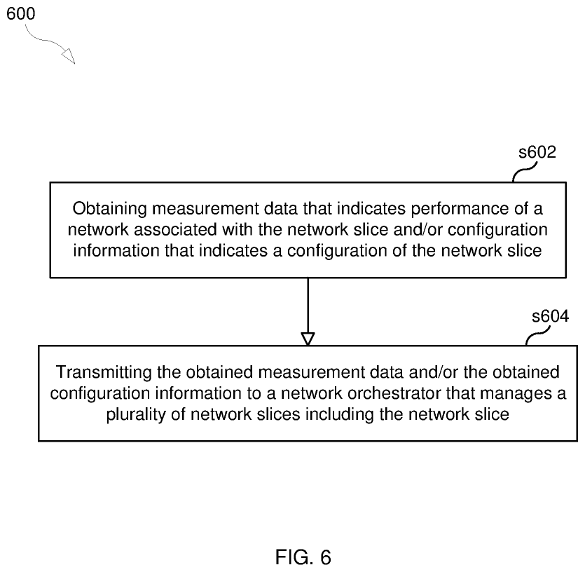

FIG. 6 shows a process 600 performed by the NE 104 (i.e., a network slice controller associated with a network slice) according to some embodiments. Process 600 may begin with step s602. Step s602 comprises obtaining measurement data that indicates performance of a network associated with the network slice and/or configuration information that indicates a configuration of the network slice. Step s604 comprises transmitting the obtained measurement data and/or the obtained configuration information to a network orchestrator that manages a plurality of network slices including the network slice. The network slice controller and the network orchestrator belong to a common network operator or a common vertical.

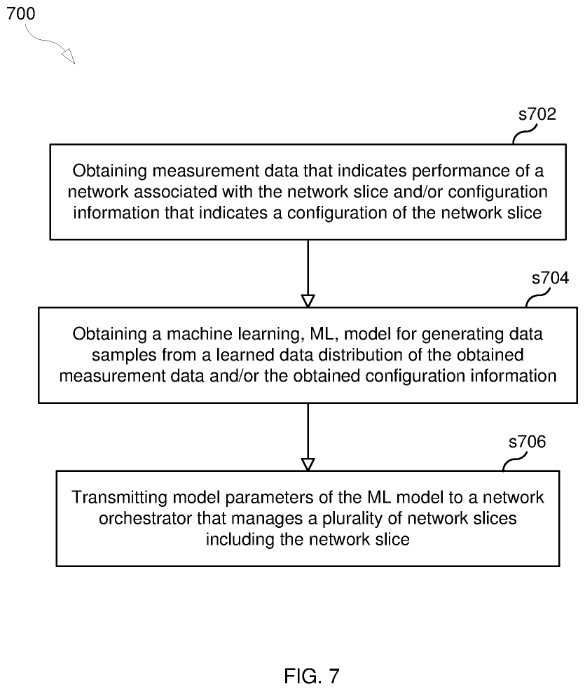

FIG. 7 shows a process 700 performed by the NE 108 (i.e., a network slice controller associated with a network slice) according to some embodiments. Process 700 may begin with step s702. Step s702 comprises obtaining measurement data that indicates performance of a network associated with the network slice and/or configuration information that indicates a configuration of the network slice. Step s704 comprises obtaining a machine learning, ML, model for generating data samples from a learned data distribution of the obtained measurement data and/or the obtained configuration information. Step s706 comprises transmitting model parameters of the ML model to a network orchestrator that manages a plurality of network slices including the network slice. The network slice controller and the network orchestrator belong to different network operators or verticals.

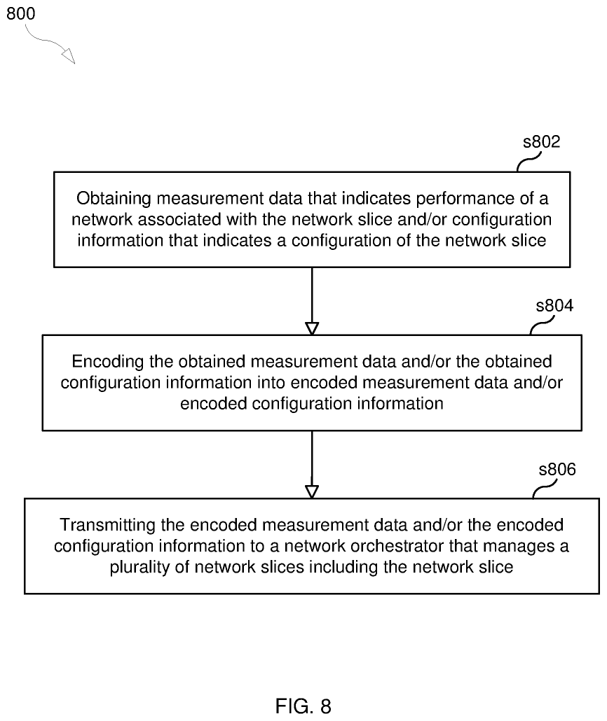

FIG. 8 shows a process 800 performed by the NE 106 (i.e., a network slice controller associated with a network slice) according to some embodiments. Process 800 may begin with step s802. Step s802 comprises obtaining measurement data that indicates performance of a network associated with the network slice and/or configuration information that indicates a configuration of the network slice. Step s804 comprises encoding the obtained measurement data and/or the obtained configuration information into encoded measurement data and/or encoded configuration information. Step s806 comprises transmitting the encoded measurement data and/or the encoded configuration information to a network orchestrator that manages a plurality of network slices including the network slice. The network slice controller and the network orchestrator belong to different network operators or verticals.

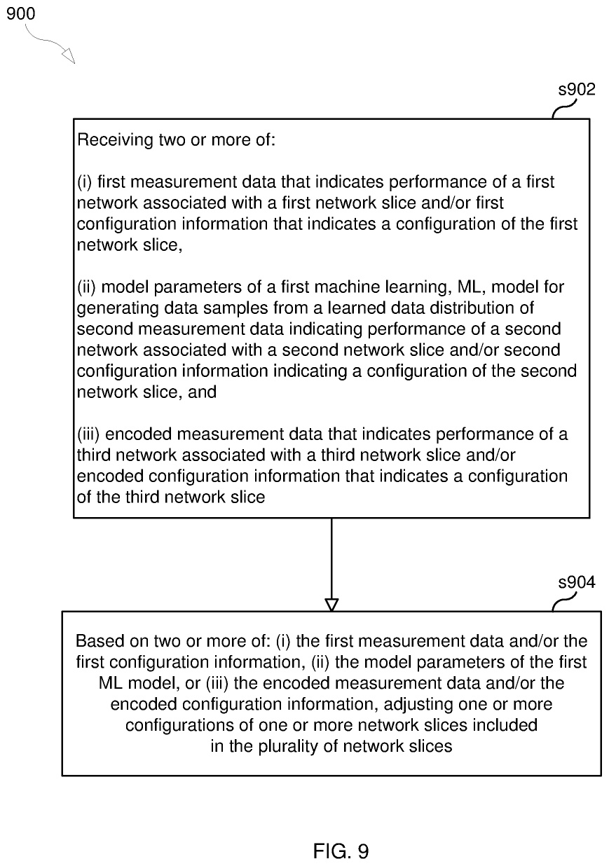

FIG. 9 shows a process 900 performed by the network orchestrator 132 (which manages a plurality of network slices) according to some embodiments. Process 900 may begin with step s902. Step s902 comprises receiving two or more of: (i) first measurement data that indicates performance of a first network associated with a first network slice and/or first configuration information that indicates a configuration of the first network slice, (ii) model parameters of a first machine learning, ML, model for generating data samples from a learned data distribution of second measurement data indicating performance of a second network associated with a second network slice and/or second configuration information indicating a configuration of the second network slice, and (iii) encoded measurement data that indicates performance of a third network associated with a third network slice and/or encoded configuration information that indicates a configuration of the third network slice. Step s904 comprises, based on two or more of: (i) the first measurement data and/or the first configuration information, (ii) the model parameters of the first ML model, or (iii) the encoded measurement data and/or the encoded configuration information, adjusting one or more configurations of one or more network slices included in the plurality of network slices. The first measurement data and/or the first configuration information were transmitted by a first network slice controller associated with the first network slice. The model parameters of the first ML model were transmitted by a second network slice controller associated with the second network slice. The encoded measurement data and/or the encoded configuration information were transmitted by a third network slice controller associated with the third network slice. The first network slice controller and the network orchestrator belong to a common network operator or a common vertical. The second network slice controller and the network orchestrator belong to different network operators or verticals. The third network slice controller and the network orchestrator belong to different network operators or verticals.

In some embodiments, receiving two or more of (i) the first measurement data and/or the first configuration information, (ii) the model parameters of the first ML model, and (iii) the encoded measurement data and/or the encoded configuration information comprises receiving all of (i) the first measurement data and/or the first configuration information, (ii) the model parameters of the first ML model, and (iii) the encoded measurement data and/or the encoded configuration information.

In some embodiments, the process 900 comprises transmitting, to each of one or more of the first network slice controller, the second network slice controller, and the third network slice controller, a request to provide level data which indicates a privacy level associated with a network slice controller; and after transmitting the request to provide level data, receiving the requested level data from each of one or more of the first network slice controller, the second network slice controller, and the third network slice controller.

In some embodiments, the process 900 comprises, after receiving the requested level data, transmitting, to each of one or more of the first network slice controller, the second network slice controller, and the third network slice controller, a request to provide feedback information, wherein the request to provide feedback information includes a type indicator indicating one of different types of the feedback information, and the different types of the feedback information are associated with different privacy levels.

In some embodiments, the first measurement data and/or the first configuration information corresponds to a first type of the feedback information, the model parameters of the first ML model correspond to a second type of the feedback information, and the encoded measurement data and/or the encoded configuration information corresponds to a third type of feedback information.

In some embodiments, the first type of feedback information is associated with a first privacy level, the second type of feedback information is associated with a second privacy level, the third type of feedback information is associated with a third privacy level, the second privacy level is higher than the first privacy level, and the third privacy level is higher than the second privacy level.

In some embodiments, the process 900 comprises transmitting, to each of one or more of the first network slice controller, the second network slice controller, and the third network slice controller, a request to provide feedback information, wherein the feedback information is any one of: (i) the first measurement data and/or the first configuration information, (ii) the model parameters of the ML model, or (iii) the encoded measurement data.

In some embodiments, the process 900 comprises in case the network orchestrator received the model parameters of the first ML model, using the first ML model to generate data samples from the learned data distribution of the second measurement data and/or the second configuration information; and providing, to a second ML model, the generated data samples, thereby generating estimated measurement data that estimates performance of the second network associated with the second network slice and/or estimated configuration information that estimates a configuration of the second network slice.

In some embodiments, the process 900 comprises in case the network orchestrator received the encoded measurement data and/or the encoded configuration information, using a mapping function to convert the encoded measurement data and/or the encoded configuration information into converted-encoded measurement data and/or converted-encoded configuration information; and providing the converted-encoded measurement data and/or the converted-encoded configuration information to a decoding ML model, thereby decoding the converted-encoded measurement data and/or the converted-encoded configuration information into decoded measurement data that estimates performance of the third network associated with the third network slice and/or decoded configuration information that estimates a configuration of the third network slice.

In some embodiments, the process 900 comprises providing to a network configuring ML model (i) the first measurement data and/or the first configuration information, (ii) the estimated measurement data and/or the estimated configuration information, and (iii) the decoded measurement data and/or the decoded configuration information, thereby generating one or more network configuration parameters; and adjusting one or more configurations of the first network slice, the second network slice, and/or the third network slice using said one or more network configuration parameters.

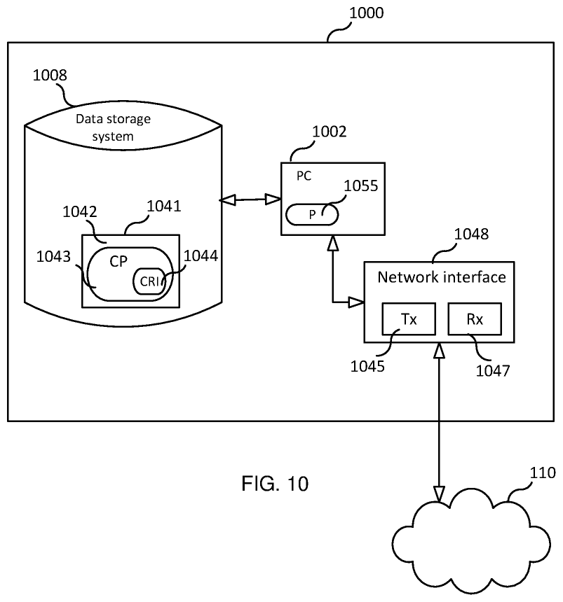

FIG. 10 is a block diagram of an apparatus 1000, according to some embodiments, for implementing any one of the NE 104, 106, 108 or the network orchestrator 132. As shown in FIG. 10, apparatus 1000 may comprise: processing circuitry (PC) 1002, which may include one or more processors (P) 1055 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 1000 may be a distributed computing apparatus); a network interface 1048 comprising a transmitter (Tx) 1045 and a receiver (Rx) 1047 for enabling apparatus 1000 to transmit data to and receive data from other nodes connected to a network 110 (e.g., an Internet Protocol (IP) network) to which network interface 1048 is connected (directly or indirectly) (e.g., network interface 1048 may be wirelessly connected to the network 110, in which case network interface 1048 is connected to an antenna arrangement); and a local storage unit (a.k.a., “data storage system”) 1008, which may include one or more non-volatile storage devices and/or one or more volatile storage devices. In embodiments where PC 1002 includes a programmable processor, a computer program product (CPP) 1041 may be provided. CPP 1041 includes a computer readable medium (CRM) 1042 storing a computer program (CP) 1043 comprising computer readable instructions (CRI) 1044. CRM 1042 may be a non-transitory computer readable medium, such as, magnetic media (e.g., a hard disk), optical media, memory devices (e.g., random access memory, flash memory), and the like. In some embodiments, the CRI 1044 of computer program 1043 is configured such that when executed by PC 1002, the CRI causes apparatus 1000 to perform steps described herein (e.g., steps described herein with reference to the flow charts). In other embodiments, apparatus 1000 may be configured to perform steps described herein without the need for code. That is, for example, PC 1002 may consist merely of one or more ASICs. Hence, the features of the embodiments described herein may be implemented in hardware and/or software.

### CONCLUSION

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more”.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method performed by a network slice controller associated with a network slice, the method comprising:
obtaining measurement data that indicates performance of a network associated with the network slice and/or configuration information that indicates a configuration of the network slice; and
transmitting the obtained measurement data and/or the obtained configuration information to a network orchestrator that manages a plurality of network slices including the network slice, wherein
the network slice controller and the network orchestrator belong to a common network operator or a common vertical.

2. A method performed by a network slice controller associated with a network slice, the method comprising:
obtaining measurement data that indicates performance of a network associated with the network slice and/or configuration information that indicates a configuration of the network slice;
obtaining a machine learning (ML) model for generating data samples from a learned data distribution of the obtained measurement data and/or the obtained configuration information; and
transmitting model parameters of the ML model to a network orchestrator that manages a plurality of network slices including the network slice, wherein
the network slice controller and the network orchestrator belong to different network operators or verticals.

3. A method performed by a network slice controller associated with a network slice, the method comprising:
obtaining measurement data that indicates performance of a network associated with the network slice and/or configuration information that indicates a configuration of the network slice;
encoding the obtained measurement data and/or the obtained configuration information into encoded measurement data and/or encoded configuration information; and
transmitting the encoded measurement data and/or the encoded configuration information to a network orchestrator that manages a plurality of network slices including the network slice, wherein
the network slice controller and the network orchestrator belong to different network operators or verticals.

4. A method performed by a network orchestrator managing a plurality of network slices, the method comprising:
receiving two or more of: (i) first measurement data that indicates performance of a first network associated with a first network slice and/or first configuration information that indicates a configuration of the first network slice, (ii) model parameters of a first machine learning (ML) model for generating data samples from a learned data distribution of second measurement data indicating performance of a second network associated with a second network slice and/or second configuration information indicating a configuration of the second network slice, and (iii) encoded measurement data that indicates performance of a third network associated with a third network slice and/or encoded configuration information that indicates a configuration of the third network slice; and
based on two or more of: (i) the first measurement data and/or the first configuration information, (ii) the model parameters of the first ML model, or (iii) the encoded measurement data and/or the encoded configuration information, adjusting one or more configurations of one or more network slices included in the plurality of network slices, wherein
the first measurement data and/or the first configuration information were transmitted by a first network slice controller associated with the first network slice,
the model parameters of the first ML model were transmitted by a second network slice controller associated with the second network slice,
the encoded measurement data and/or the encoded configuration information were transmitted by a third network slice controller associated with the third network slice,
the first network slice controller and the network orchestrator belong to a common network operator or a common vertical,
the second network slice controller and the network orchestrator belong to different network operators or verticals, and
the third network slice controller and the network orchestrator belong to different network operators or verticals.

5. The method of claim 4, wherein
receiving two or more of (i) the first measurement data and/or the first configuration information, (ii) the model parameters of the first ML model, and (iii) the encoded measurement data and/or the encoded configuration information comprises receiving all of (i) the first measurement data and/or the first configuration information, (ii) the model parameters of the first ML model, and (iii) the encoded measurement data and/or the encoded configuration information.

6. The method of claim 4, wherein
transmitting, to each of one or more of the first network slice controller, the second network slice controller, and the third network slice controller, a request to provide level data which indicates a privacy level associated with a network slice controller; and
after transmitting the request to provide level data, receiving the requested level data from each of one or more of the first network slice controller, the second network slice controller, and the third network slice controller.

7. The method of claim 6, wherein
the method further comprises, after receiving the requested level data, transmitting, to each of one or more of the first network slice controller, the second network slice controller, and the third network slice controller, a request to provide feedback information,
the request to provide feedback information includes a type indicator indicating one of different types of the feedback information, and
the different types of the feedback information are associated with different privacy levels.

8. The method of claim 7, wherein
the first measurement data and/or the first configuration information corresponds to a first type of the feedback information,
the model parameters of the first ML model correspond to a second type of the feedback information, and
the encoded measurement data and/or the encoded configuration information corresponds to a third type of feedback information.

9. The method of claim 8, wherein
the first type of feedback information is associated with a first privacy level,
the second type of feedback information is associated with a second privacy level,
the third type of feedback information is associated with a third privacy level,
the second privacy level is higher than the first privacy level, and
the third privacy level is higher than the second privacy level.

10. The method of claim 4, wherein
the method further comprises transmitting, to each of one or more of the first network slice controller, the second network slice controller, and the third network slice controller, a request to provide feedback information, and
the feedback information comprises:
(i) the first measurement data and/or the first configuration information,
(ii) the model parameters of the ML model, and/or
(iii) the encoded measurement data.

11. The method of claim 4, wherein
the method further comprises:
in case the network orchestrator received the model parameters of the first ML model, using the first ML model to generate data samples from the learned data distribution of the second measurement data and/or the second configuration information; and
providing, to a second ML model, the generated data samples, thereby generating estimated measurement data that estimates performance of the second network associated with the second network slice and/or estimated configuration information that estimates a configuration of the second network slice.

12. The method of claim 4, wherein
the method further comprises:
in case the network orchestrator received the encoded measurement data and/or the encoded configuration information, using a mapping function to convert the encoded measurement data and/or the encoded configuration information into converted-encoded measurement data and/or converted-encoded configuration information; and
providing the converted-encoded measurement data and/or the converted-encoded configuration information to a decoding ML model, thereby decoding the converted-encoded measurement data and/or the converted-encoded configuration information into decoded measurement data that estimates performance of the third network associated with the third network slice and/or decoded configuration information that estimates a configuration of the third network slice.

13. The method of claim 12, wherein
the method further comprises:
providing to a network configuring ML model (i) the first measurement data and/or the first configuration information, (ii) the estimated measurement data and/or the estimated configuration information, and (iii) the decoded measurement data and/or the decoded configuration information, thereby generating one or more network configuration parameters; and
adjusting one or more configurations of the first network slice, the second network slice, and/or the third network slice using said one or more network configuration parameters.

14-16. (canceled)
